(19) United States
(12) Patent Application Publication
(10) Pub. No.: US 2009/0319363 A1
(43) Pub. Date: Dec. 24, 2009

(54) ACTIVITY VERIFICATION SYSTEM AND METHOD

(76) Inventors: Thomas Callaghan, Seattle, WA (US); Andrew Watts-Curnow, Seattle, WA (US)

Correspondence Address: AXIOS LAW GROUP. PLLC, 1525 4TH AVE, STE 800, SEATTLE, WA, 98101-1648, US

(21) Appl. No.: 12/488,149

(22) Filed: Jun. 19, 2009

Related U.S. Application Data
(60) Provisional application No. 61/074,586, filed on Jun. 20, 2008.
(60) Provisional application No. 61/146,364, filed on Jan. 22, 2009.

(51) Int. Cl. G06Q 30/00; G06F 15/16; G06Q 40/00

(52) U.S. Cl. 705/14.36; 709/224; 705/30; 705/14.71; 705/39

(57) ABSTRACT

A activity-completion verification system and method are provided herein.

### CROSS REFERENCE TO RELATED APPLICATIONS

This application claims the benefit of priority to U.S. Provisional Application No. 61/074,586, filed Jun. 20, 2008, and to U.S. Provisional Application No. 61/146,364, filed Jan. 22, 2009. The above-cited applications are incorporated herein by reference in their entireties, for all purposes.

### FIELD

The present disclosure relates generally to advertising, and more particularly, to a system and method for verifying completion of consumer activities in a “pay per action” advertising model.

### BACKGROUND

The Internet is a worldwide, publicly accessible network of interconnected computer networks that transmit data by packet switching using the standard Internet Protocol (“IP”). The “network of networks” consists of millions of smaller domestic, academic, business, and government networks, which together enable various services, such as electronic mail, online chat, file transfer, and the interlinked web pages and other documents of the world wide web.

The Internet is commonly used as an advertising medium. When businesses advertise, it is often to convince consumers to complete particular activities. For example, an advertiser may seek to entice consumers to engage in activities including the following:
Non-repeated purchase, e.g., buy a TV;
Trial use that may lead to repeated purchases, e.g., buy a new espresso-based beverage at a coffee chain;
Trial use that may lead to repeated use but not purchases, e.g., try a new feature on a Web site;
Activities that may lead a consumer to buy a company's products as a side-effect, e.g., an outdoor goods retailer convincing consumers to hike.

Ideally, an advertiser would have several options to pay for advertisements to induce particular activities. For example, an advertiser may opt to pay to display an advertisement to consumers, e.g., in a magazine or a Web site. Using this model, the advertiser assumes the risk that advertisement will fail to induce the consumer to contact the advertiser and/or to take the desired action. This advertising model is common on the Internet and is often referred to as “pay per impression.”

An advertiser may also opt to pay when consumers actually engage with the advertiser in some way, for example, by sending in a response to direct mail or clicking on a banner in a Website. Using this model, the advertiser assumes the risk that it will not be able to convert the consumer engagement into a desired action, such as making a purchase. This advertising model is also increasingly common on the Internet and is often referred to as “pay per click.”

An advertiser may also opt to pay only when consumers complete a desired activity, such as making a purchase. This advertising model is currently the least common on the Internet and is often referred to as “pay per action” (“PPA”). The term “conversion” is commonly used to refer to a consumer's having been induced by an advertisement to complete a desired activity.

While “pay per impression” and “pay per click” advertising is available for many types of desired actions, the type of actions for which “pay per action” is available tends to be more limited because of the difficulty in tracking and verifying conversions. Examples of actions for which “pay per action” are available include:
Getting consumers to buy products off-line (e.g., coupons)
Getting a consumer to buy a product online
Getting a consumer to register to a Web-site online

In the above examples, it may be relatively simple to verify that the consumer actually completed the activity. Similarly, where purchases are involved, it is often relatively easy to motivate consumers (e.g., by providing a discount or rebate). However, for many other actions that an advertiser might desire, motivating and verifying are significantly more difficult. Consequently, “pay per action” is limited in use today.

Current solutions may have difficulty providing “pay per action” models that are effective for a wide range of desired actions at getting consumers to notice activities, motivating consumers to perform activities, verifying completed activities, and/or monetizing an activity platform.

### BRIEF DESCRIPTION OF THE DRAWINGS

FIG. 1 is a system diagram showing a number of interconnected devices in accordance with one embodiment.

FIG. 2 is a block diagram of a device that provides an exemplary operating environment for various embodiments.

FIG. 3 is a data flow diagram illustrating a user online activity sequence in accordance with one embodiment.

FIG. 4 is a flow diagram illustrating an activity promotion and verification routine in accordance with one embodiment.

FIG. 5 is a flow diagram illustrating an activity verification subroutine in accordance with one embodiment.

FIG. 6 is a flow diagram illustrating an obtain unverified activity indication subroutine in accordance with one embodiment.

FIG. 7 is a flow diagram illustrating an activity completion verification subroutine in accordance with one embodiment.

FIG. 8 is an illustration of a online activity verification user interface window in accordance with one embodiment.

FIGS. 9-11 are data flow diagrams illustrating various activities related to a commitment mechanism in accordance with various embodiments.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

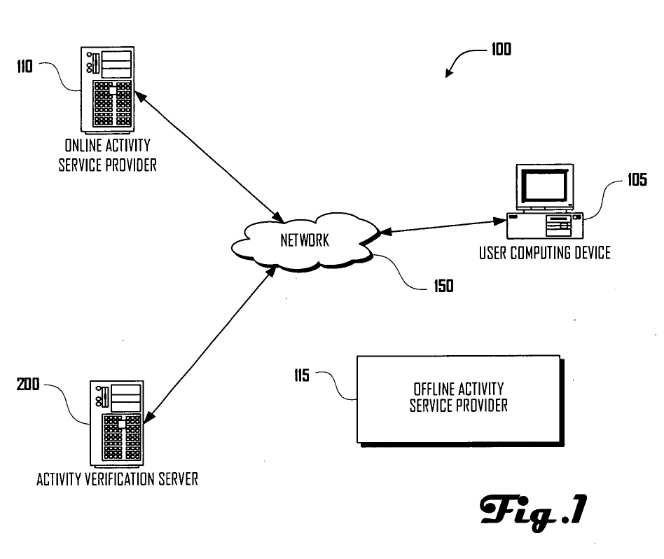

FIG. 1 illustrates a number of interconnected devices in accordance with one embodiment. User computing device 105, online activity service provider 110, and activity verification server 200 are connected to network 150. Offline activity service provider 115 may or may nor be connected to network 150, which routes and/or propagates information between components of the system. In various embodiments, network 150 comprises communication switching, routing, and/or data storage capabilities. In various embodiments, network 150 may comprise some or all of the Internet, one or more intranets, and wired and/or wireless network portions. In various embodiments, there may be more than one online/offline activity service provider 110/115, user computing device 105, and/or activity verification server 200.

User computing device 105 may be any device that is capable of online activity, including desktop computers, laptop computers, mobile phones and other mobile devices, PDSs, set-top boxes, game devices, appliances, and the like.

As used herein, the term “online” refers to a state of being connected to a network, such as network 150. Conversely, the term “offline” refers to a state of being disconnected from a network, such as network 150. The term “online activity” refers to an activity that may be performed while online. Conversely, the term “offline activity” refers to an activity that may be performed while offline. Thus, “offline activity” service provider 115 refers to an entity that provides an offline service and/or facility by which one or more potential offline activities may be performed. Similarly, online activity service provider 110 refers to an entity that provides an online service and/or facility by which one or more potential online activities may be performed. If the context so dictates, online activity service provider 110 may also refer to servers, server clusters, virtualized servers, web services, and/or other computing devices operated by or at the direction of such an entity.

By way of example, an illustrative offline activity may include drinking a cinnamon dolce latte at Starbucks. In this context, Starbucks Corporation of Seattle Wash. may be considered to be an “offline activity” service provider 115. Other illustrative offline activities may include viewing an exhibit at a facility provided by the Pacific Science Center

Conversely, an illustrative online activity may include watching a streaming video advertisement for Starbucks cinnamon dolce lattes at starbucks.com. In this context, Starbucks Corporation of Seattle Wash. (and/or computing devices operated by/for Starbucks) may also be considered to be an “online activity” service provider 110.

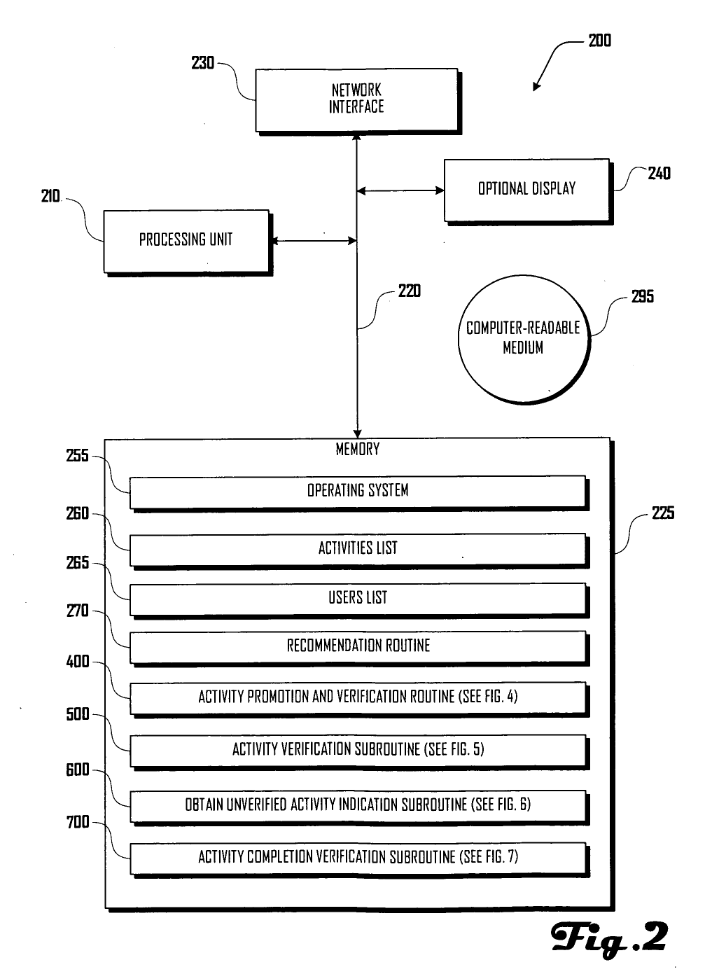

FIG. 2 illustrates several components of an exemplary activity verification server 200. In some embodiments, activity verification server 200 may include many more components than those shown in FIG. 2. However, it is not necessary that all of these generally conventional components be shown in order to disclose an illustrative embodiment. As shown in FIG. 2, activity verification server 200 includes a network interface 230 for connecting to network 150. Network interface 230 includes the necessary circuitry for such a connection and is constructed for use with an appropriate protocol.

Activity verification server 200 also includes a processing unit 210, a memory 225, and an optional display 240, all interconnected, along with network interface 230, via bus 220. Memory 250 generally comprises a random access memory (“RAM”), a read only memory (“ROM”), and/or a permanent mass storage device, such as a disk drive. In some embodiments, memory 250 may also comprise a local and/or remote database, database server, and/or database service. Memory 250 stores program code for some or all of a list of activities 260, a list of users 265, a recommendation routine 270, an activity promotion and verification routine 400, an activity verification subroutine 500, an obtain unverified activity indication subroutine 600, and an activity completion verification subroutine 700. In addition, memory 250 also stores an operating system 255. These and other software components may be loaded from a computer readable storage medium 295 into memory 250 of activity verification server 200 using a drive mechanism (not shown) associated with a computer readable storage medium 295, such as a floppy disc, tape, DVD/CD-ROM drive, memory card. In some embodiments, software components may also be loaded via the network interface 230 or other non-storage media.

In some embodiments, activity verification server 200 may comprise one or more devices such as that illustrated in FIG. 2. In other embodiments, activity verification server 200 may comprise one or more virtualized servers, web services, and/or other computing devices operated by or at the direction of an activity verification online service provider. In still further embodiments, some or all of recommendation routine 270, activity promotion and verification routine 400, activity verification subroutine 500, obtain unverified activity indication subroutine 600, and activity completion verification subroutine 700 may be performed by a user computing device 105 executing instructions associated with, provided by, and/or provided at the direction of an activity verification online service provider. For example, in some embodiments, some or all of these routines may be performed by a desktop activity verification software client and/or an activity verification browser plug-in, either of which may communicate with an activity verification server 200 and/or other computing devices operated by or at the direction of an activity verification online service provider.

In some embodiments, users may interact with activity verification server 200 via network 150 in a variety of ways. For example, in one embodiment, a user may submit an “activity indication,” or a “claim” that he or she has performed a particular activity. In some embodiments, activity verification server 200 may keep track of the number of claimed “completions” of each activity and may show comparisons of the activities based on how many people have claimed to have completed them.

In some embodiments, list of activities 260 may also include a variety of information about some or all of the listed activities. For example, an activity might include a title, descriptive text, images, video, tags, and the like.

In an exemplary embodiment, activity verification server 200 may collect activity information from users. For example, activity information may include some or all of the following: how long it takes to complete the activity; how difficult it is to complete the activity; how valuable it is to complete the activity. In one embodiment, users may rate less objective pieces of data (e.g., how difficult and how valuable) according to an arbitrary numerical scale, e.g., 1-10.

Activity information thus collected may be presented in various ways, including, for example, in raw form, as an arithmetic average, and/or as an arithmetic average of information only from people who claim to have completed the activity. In some embodiments, an “expected” number for each type of data may be derived from user-supplied information, e.g., “expected time” (“XT”), “expected difficulty” (“XD”), and “expected value” (“XV”). In another embodiment, users may enter comparisons between activities, e.g., ordering the time taken, difficulty, or value of completing two or more activities. These and other aspects of activity information are discussed in greater detail in Appendix A, below.

In one embodiment sub-sets of activities may be created and/or ranked in accordance with such information. For example, a sub-set might be formed comprising all activities tagged “Seattle” that at least 10 people claimed to complete. Activities within that sub-set may also be ranked by difficulty.

Activities and/or activity information may be displayed in a variety of ways. In one embodiment, activities and/or activity information may be displayed via one or more Web sites i) hosted on one or more activity verification servers 200 and/or ii) administered by an activity verification online service provider. In some embodiments, activity verification online service provider may operate one or more themed activity verification servers 200 (e.g., one with activities involving sports, another with activities involving fashion, and the like). In other embodiments, activities and/or activity information may be displayed via affiliate Web sites. In some embodiments, such affiliates may receive a payment when a revenue-generating activity can be correlated with i) a user of an activity verification online service provider; ii) an activity indication received by an activity verification online service provider; and/or iii) an activity promoted by an activity verification online service provider.

As mentioned above, memory 255 of activity verification server 200 may include a list of users 265. In some embodiments, list of users 265 may be stored in a local and/or remote database, database server, and/or database service.

In various embodiments, list of users 265 may store information associated with users it has obtained information from and/or interacted with. In this context, a “user” may or may not have explicitly identified him- or her-self to and/or registered with activity verification server 200. For example, a user may merely have been invited by an acquaintance, or a user may have visited, but not registered at, a site hosted by activity verification server 200. A user may include a person acting as a consumer, a person acting as a representative of a business or organizations, and the like. In one embodiment, a user may be able to interact with other users in a variety of ways, including interactions common in “social-networking” applications, e.g., viewing each other's profiles, sending messages to each other, registering each other as “friends,” and the like. User profiles and other aspects of user information are discussed in greater detail in Appendix A, below.

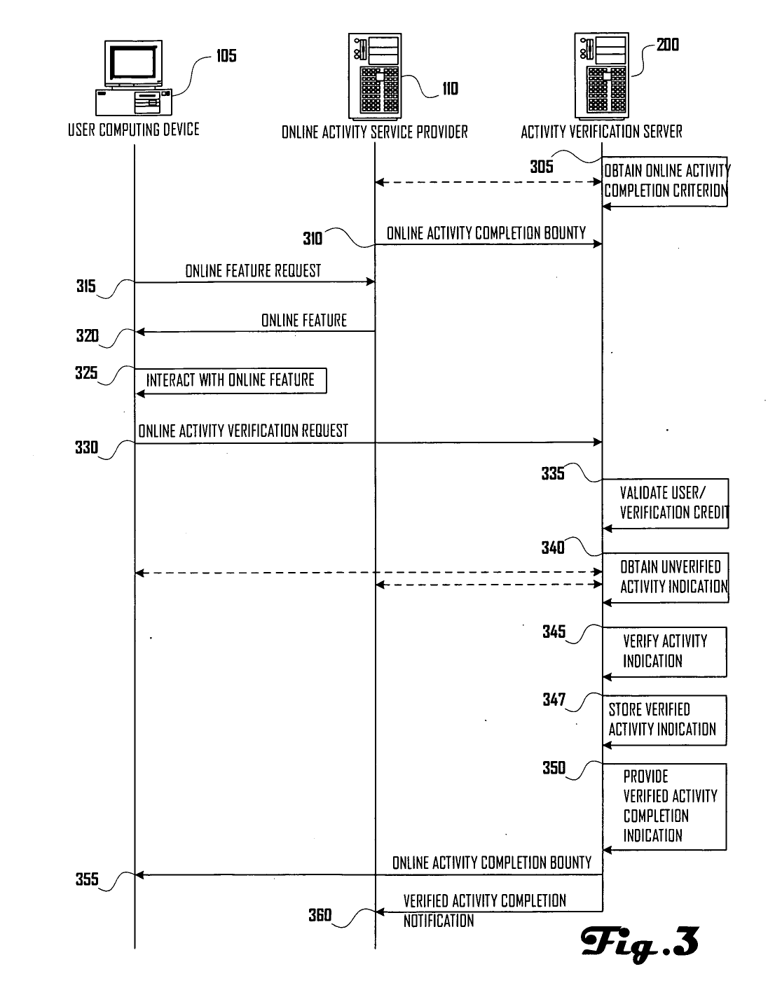

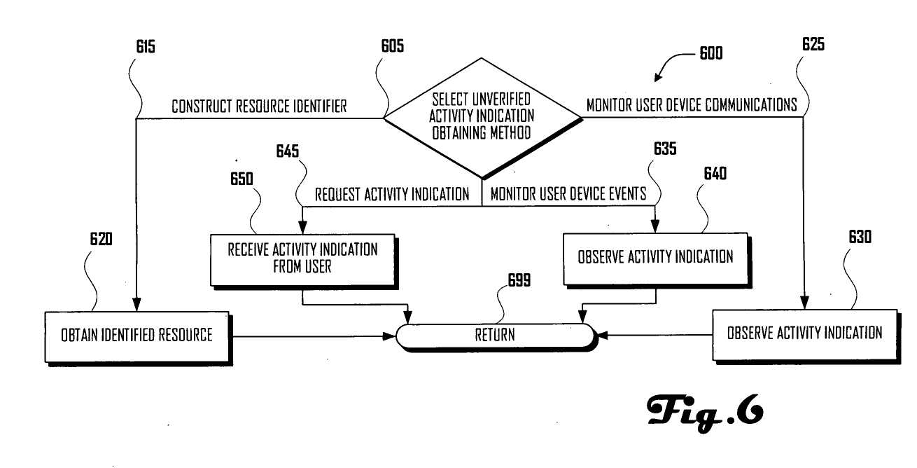

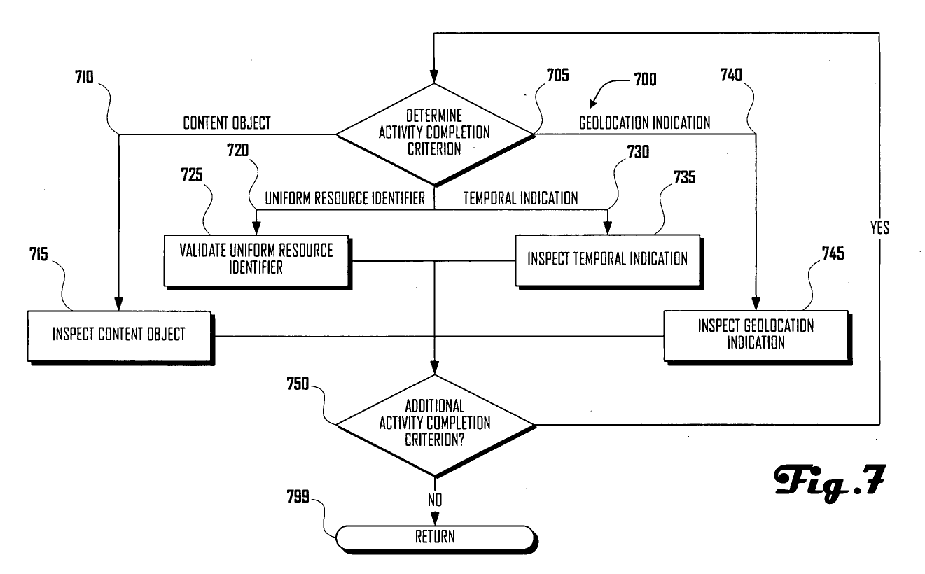

FIG. 3 is a data flow diagram illustrating a user online activity sequence in accordance with one embodiment. In the illustrated sequence, activity verification server 200 obtains 305 an online activity completion criterion. As used herein, the term “activity completion criterion” refers to a criterion that activity verification server 200 may use to determine whether an activity indication submitted by a user is sufficient “proof” that the user actually performed the activity. In some embodiments, obtaining 305 the online activity completion criterion may include communication with online activity service provider 110. Activity completion criteria are discussed in greater detail below in reference to FIGS. 6-7.

In the illustrated sequence, online activity service provider 110 optionally provides 310 an activity completion bounty to activity verification server 200. As used herein, the term “bounty” refers to a reward, gift, and/or payment to be provided to a user who verifiably completes an activity. In some embodiments, a bounty may comprise a payment in a real and/or virtual currency. In other embodiments, a bounty may comprise a coupon and/or voucher for goods and/or services. For example, in one embodiment, a bounty may comprise a verification credit. Other embodiments may use other payment units, or mixtures of payment units, such as real currency, airline miles, lottery participation rights, beads, and the like.

In the sequence illustrated in FIG. 3, user computing device 105 requests 315 an online feature from online activity service provider 110. In some embodiments, requesting an online feature may comprise requesting data for a particular web page. For example, in the case of the exemplary online activity, “Create a Listmania List” at Amazon.com, requesting 315 an online feature may comprise requesting a “Listmania” list creation web page from Amazon.com. Online activity service provider 110 sends 320 the requested online feature to user computing device 105, and the user interacts 325 with the online feature at user computing device 105. In some embodiments, interacting 325 with the online feature may comprise additional communications (not shown) between user computing device 105 and online activity service provider 110.

Having interacted with the online feature, user computing device 105 submits 330 an online activity verification request to activity verification server 200. In some embodiments, submitting an online activity verification request may comprise requesting a web page and/or submitting a HyperText Markup Language (“HTML”)form.

In some embodiments, activity verification server 200 validates 335 the user and/or validates the user's verification credits. For example, activity verification server 200 may request an authentication credential (e.g., a password) from the user. In other embodiments, the user may not have signed-up and/or registered with activity verification server 200 at the time the activity verification request is submitted. In some such embodiments, the unregistered user's activity indications and/or verifications may be stored temporarily, e.g. in a cookie in the unregistered user's Web browser, until such time as the user does sign-up and/or register.

In some embodiments, activity verification server 200 may maintain a record of “verification credits” the user may have obtained. In various embodiments, a user may obtain one or more verification credits by, for example, registering as a user with activity verification server 200, performing other verified activities, purchasing verification credits with real and/or virtual currency, and the like. In other embodiments, a verification credit may comprise a single- or multiple-use code and/or voucher, which user computing device 105 may submit to activity verification server 200 along with or in addition to an activity verification request. In some embodiments, activity verification server 200 may continue to process the activity verification request only when it has verified that the user has sufficient verification credits.

Activity verification server 200 obtains 340 an unverified activity indication. In some embodiments, obtaining 340 unverified activity indication may comprise communicating with online activity service provider 110. For example, in one embodiment, activity verification server 200 may retrieve a Uniform Resource Locator (“URL”) or other Uniform Resource Identifier (“URI”) associated with a particular activity. In another embodiment, activity verification server 200 may retrieve a content object, e.g., an HTML page, an Extensible Markup Language (“XML”) document, a JavaScript Object Notation (“JSON”) object, and the like. In other embodiments, obtaining 340 unverified activity indication may comprise communicating with user computing device 105. For example, activity verification server 200 may request that the user provide an indication and/or an address of a Web resource where an indication may be obtained.

Once it has obtained an activity indication, activity verification server 200 verifies 345 the activity indication and stores 347 the verified activity indication. (See FIGS. 6-7 and associated text, below.) Assuming that activity verification server 200 verifies the activity indication, activity verification server 200 provides 350 a verified activity completion indication. For example, in some embodiments, activity verification server 200 may provide a “badge” and/or profile showing the verified activity completion indication, and the user may be able to publish the badge and/or profile to a blog, social network profile page, e-mail “signature,” and the like.

In some embodiments, when online activity service provider 110 has provided a “bounty,” activity verification server 200 may send 355 the bounty to user computing device 105 and/or to another device or facility associated with the user. For example, in one embodiment, activity verification server 200 may send an e-mail, text message, “tweet,” and/or other electronic message to an address associated with the user.

In some embodiments, activity verification server 200 may further notify 360 online activity service provider 110 that the user has completed a verified activity. In some embodiments, such a notification may comprise information about the activity and/or how the activity completion was verified.

In some embodiments, activity verification server 200 may provide additional services to a user (not shown). For example, in some embodiments, activity verification server 200 may recommend activities to users.

In various embodiments, one or more recommendation algorithms may be used to determine activities to be recommended to a user. In one embodiment, activities with a high number of completions over some span of time (e.g., “Hot” activities) may be recommended. In another embodiment, a particular user's completions and ratings may be compared with activities that other users have completed and/or rated. A user may receive recommendations to do activities that “similar” users (those who completed and/or valued activities similarly) completed and/or valued highly. In a further embodiment, activities that are popular with a set of other users may be recommended. In some embodiments, the pool of users from which recommendations are drawn may be limited in various ways, e.g., by degree of friendship, by completion of activities with a particular tag, and the like. For example, activities may be recommended that are tagged “soccer” and that have been completed the most within the last 30 days by friends and friends-of-friends.

In yet another embodiment, activities may be recommended based at least in part on difficulty. For example, activities may be recommended according to an upward-sloping sin wave of difficulty ratings. Similar techniques could be applied with time and/or value ratings substituted for difficulty ratings.

In a still further embodiment, activities may be recommended to a user based on what other users have done, goading the person to “beat” the other users. For example, a user might be goaded to compete with one of his or her “friends” (e.g., other users who have indicated some kind of relationship with the user) who has the greatest overlap of completed activities to the user. The user may receive recommendations to complete activities that the friend has completed but the user has not, with the suggestion that the user could “beat” the friend by completing those activities.

In another exemplary embodiment, activities may be recommended based on the concept that a user can always be the “king” of some “hill,” and that completing more activities allows a user to become a “king” of ever bigger “hills.” For example, a user's completed activities may indicate that that user has completed more activities tagged “alligator” than any of his or her friends and friends-of-friends in the last 30 days. The user might be informed that he or she is “king” of the “alligator hill” among friends and friends-of-friends. In some embodiments, the user might further be encouraged to complete an additional activity tagged “alligator” within a period of time, in which case, the user may enlarge the “hill” that he or she is “king” of to include friends-of-friends-of-friends (unless another user within that circle beats the user by completing additional activities tagged “alligator” before the user does).

In various embodiments, some or all of the above-described algorithms may be combined to generate a recommendation for a user.

Once a recommendation has been created, it may be delivered to the user through one or more channels. For example, in one embodiment, a recommendation may be delivered via a recommendation Web page. In other embodiments, recommendations may be delivered via user-like avatars (“DareBots”), which may challenge users to perform recommended activities. In still further embodiments, recommendations may be delivered via other methods, including e-mail, text messages, automated phone calls, and the like.

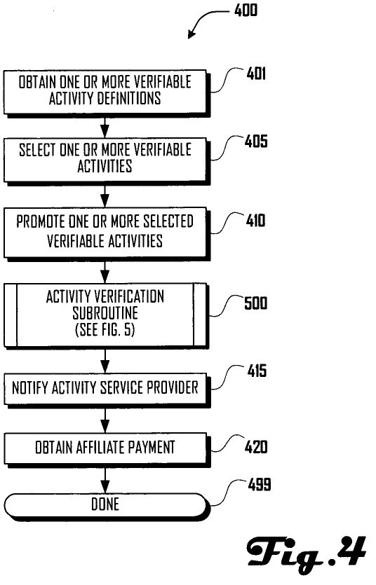

FIG. 4 is a flow diagram illustrating an activity promotion and verification routine 400 in accordance with one embodiment. In block 401, routine 400 obtains one or more verifiable activity definitions. In some embodiments, routine may obtain a one or more pre-defined verifiable activity definitions. In other embodiments, a user and/or an online activity service provider 110 define a verifiable activity. In one embodiment, a verifiable activity definition may comprise two or more sub-activities connected by logical operators such as “AND,” “OR,” “NOT,” “IF/THEN,” and the like.

In block 405, routine 400 selects one or more verifiable activities. In some embodiments, the one or more verifiable activities may be selected from a list and/or database of verifiable activities. In one embodiment, the selection may be based at least in part on whether an online activity service provider 110 has provided a completion bounty and/or a sponsorship payment to an activity verification online service provider that operates activity verification server 200.

In block 410, routine 400 promotes the one or more selected activities. In one embodiment, promoting the selected activities may comprise displaying the selected activities in a “featured” section of a web page. In other embodiments, promoting the selected activities may comprise advertising the selected activities, sending users messages including references to the selected activities, and the like.

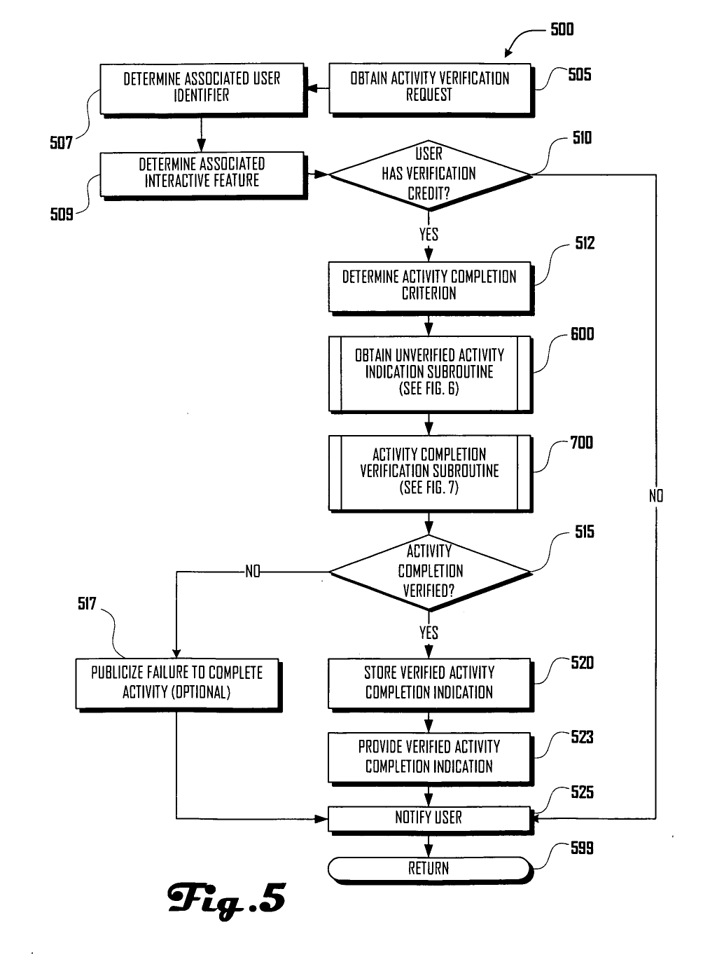

In block 500, routine 400 performs an activity verification subroutine, as illustrated in FIG. 5 and discussed below. In block 415, routine 400 optionally notifies the activity service provider that a user has verifiably completed one of the activity service provider's activities.

In block 420, routine 400 optionally obtains an affiliate payment associated with the verifiably completed activity. For example, while completing an exemplary online activity, “Create a Listmania List” at Amazon.com, the user may have purchased a book or other item from Amazon.com. Accordingly, in one embodiment, Amazon.com may make an “affiliate” payment to activity verification online service provider, in exchange for promoting the activity and directing the user to perform the activity at Amazon.com. Routine 400 ends at block 499.

FIG. 5 is a flow diagram illustrating an activity verification subroutine 500 in accordance with one embodiment. In some embodiments, some or all of subroutine 500 may be performed by activity verification server 200. In some embodiments, some or all of subroutine 500 may be performed by a user computing device 105 executing instructions associated with, provided by, and/or provided at the direction of an activity verification online service provider. For example, in some embodiments, some or all of subroutine 500 may be performed by a desktop activity verification software client and/or an activity verification browser plug-in (not shown), either of which may communicate with an activity verification server 200 and/or other computing devices operated by or at the direction of an activity verification online service provider.

In block 505, routine 500 obtains an activity verification request. In many embodiments, an activity verification request may be initiated and/or submitted by a user. In other embodiments, a subroutine 500 may obtain an activity verification request without a user's explicit request. For example, if a user has provided an activity verification online service provider with a set of credentials to a network resource, subroutine 500 may extract information from that resource, as discussed herein, and cross-reference the extracted information against a database or list of known activities to determine whether the extracted information includes any indications that one or more activities have been completed. For example, a user may provide Amazon credentials, and subroutine 500 may review various Amazon URLs associated with the user. In an illustrative example, subroutine 500 may automatically determine that the user has already completed a “Create a Listmania List” activity, even though the user did not explicitly ask subroutine 500 to verify that activity. In some embodiments, a modified client (e.g., a web browser extension) could provide similar automatic information extraction, activity correlation, and activity verification.

In block 507, subroutine 500 determines a user identifier associated with the request. In many embodiments, a user who has registered with the activity verification online service provider may have submitted the activity verification request. In such cases, the user may have an associated user identifier (e.g., a registered user name and/or user ID) with the activity verification online service provider.

In some embodiments, user identifier may comprise another identifier that can be used to associate a user and/or a user account with the activity verification request. For example, the determined user identifier may comprise a user name and/or user ID registered with online activity service provider 110 (e.g., the determined user identifier might be an Amazon.com user name and/or user ID, or a similar identifier from another online service). In other embodiments, a user identifier may comprise an Hypertext Transfer Protocol (“HTTP”) “cookie” or other information stored on a user's computer. In yet other embodiments, a user identifier may comprise the user's first and/or last name (e.g., “John Smith”) and/or a physical identification token, such as a driver's license or other photo ID, a Radio-frequency identification (“RFID”) tag, smart card, credit and/or debit card, a two-factor authentication token, biometric information, personal identification number (“PIN”), and the like.

In still further embodiments, subroutine 500 may verify activities of one or more users who have not registered with activity verification online service provider. Evaluating a population of unregistered users may be useful for purposes such as establishing a completion frequency of one or more activities among that population. For example, a group of user identifiers (e.g., Amazon.com usemames) may be obtained from a network resource (e.g., Amazon.com), and information associated with members of the group may be evaluated to determine how frequently activities associated with the network resource are completed, regardless of whether the group members have registered with activity verification online service provider.

In block 509, routine 500 determines an interactive feature associated with the request. For example, in one embodiment, routine 500 may determine that an activity verification request is associated with user identifier “joe” and with interactive feature, “Create a Listmania List” at Amazon.com. In other embodiments, the associated interactive feature may be an offline feature. For example, in one embodiment, the associated interactive feature may be “Visit Pacific Science Center in Seattle.”

In some embodiments, the user who submitted the activity verification request may be unknown to routine 500. For example, the user may not have signed-up and/or registered with an activity verification online service provider. In such embodiments, routine 500 may determine a temporary user identifier in block 507.

In some embodiments, subroutine 500 may require that a user obtain one or more verification credits in order to verify an activity completion. In decision block 510, subroutine 500 determines whether the determined user identifier has sufficient verification credits. In some embodiments, this determining may comprise consulting a verification credit balance associated with the determined user identifier. In some embodiments, verification credits may be “consumed” when subroutine 500 verifies an activity indication, in which case subroutine 500 may further comprise debiting or removing a credit from a verification credit balance (not shown). In other embodiments, the user may include one or more verification credits along with the activity verification request obtained in block 505. If decision block 510 determines that the user does not have and/or has not submitted sufficient verification credits, subroutine 500 notifies the user in block 525, and subroutine 500 ends at block 599.

When decision block 510 determines that the user possesses and/or has submitted sufficient verification credits, subroutine 500 determines an activity completion criterion in block 512. In some embodiments, determining an activity completion criterion may comprise communicating with the activity's service provider to identify one or more criteria that would signal completion of the activity. In other embodiments, determining an activity completion criterion may comprise consulting a database and/or list of activities and/or activity completion criteria. Activity completion criteria are also discussed below in relation to FIGS. 6-7.

In block 600, subroutine 500 obtains an unverified activity indication, as illustrated in FIG. 6 and discussed below. In block 700, subroutine 500 verifies the obtained unverified activity indication, as illustrated in FIG. 7 and discussed below. In decision block 515, subroutine 500 determines whether the activity indication was successfully verified. If not, subroutine 500 optionally publicizes the user's failure to complete the activity (“shaming” the user) and notifies the user in block 525. Subroutine 500 ends at block 599. If the activity indication was successfully verified, subroutine 500 stores and “provides” the verified activity completion indication in blocks 520 and 523, respectively.

In various embodiments, verified activity completion indications may be “provided” such that a user may publicize his or her verified activity completions on a Web page, blog, micro-blog, social network, bulletin board, and/or other online forum. In some embodiments, “providing” verified activity completions may comprise maintaining user rankings and/or “leader boards” in one or more categories.

In some embodiments, the verified activity completion indication may be stored in a database or other persistent data store accessible by activity verification online service provider. If the user has not yet registered with activity verification online service provider, the activity indication may be provisionally stored on the user's device until such time as the user registers with activity verification online service provider. When the previously-unknown user registers, activity completion indications and other data provisionally-stored data may be obtained from the user's device and written to the activity verification online service provider's persistent data store.

FIG. 6 is a flow diagram illustrating an obtain unverified activity indication subroutine 600 in accordance with one embodiment. Subroutine 600 begins at decision block 605, in which subroutine 600 selects one or more of several alternative methods of obtaining an activity indication. In some embodiments, a method is chosen based at least in part on the activity completion criterion for the activity indication in question.

For example, if the activity completion criterion comprises inspecting a resource located at an URL or other URI that may be constructed using data possessed by subroutine 600, subroutine 600 may select branch 615. In one exemplary embodiment, the user may have provided a set of credentials (e.g., a user id, registered email address, and the like), possibly including a password, that may be used to access the user's account on one or more websites or other network services. The provided credentials may optionally be used to determine additional identifiers related to the user. For example, a user might provide an email address that he or she has registered with a web site such as Amazon.com. In turn, subroutine 600 may use the provided email address to identify a user name associated with the user on Amazon. In block 620, subroutine 600 may use some or all of the credentials and/or additional identifiers to construct and/or infer one or more URLs or URIs that point to pages containing information that may be treated as an indication of certain activities. In some embodiments, one or more of the constructed URLs may be accessed at multiple points in time to determine whether a previously unavailable indication has since become available.

For another example, subroutine 600 may select branch 625 when subroutine 625 is capable of monitoring communications between a user device and an online interactive feature provider. In one embodiment, a user may access an online interactive feature using a special or modified client that enables subroutine 600 to monitor communications between the modified client and online interactive service providers. For example, a user may install a web browser extension that reports to the subroutine 600 or otherwise allows the subroutine 600 to observe URLs, communications, and/or content of web pages visited using the modified browser. In various embodiments, such browser extensions may be bundled with a browser distribution, or other modified clients may be bundled with an operating system or software suite. Subroutine 600 may obtain an activity indication in block 630 by observing data passed by the modified client. In other embodiments, subroutine 600 may execute on a data communications proxy for the user's computing device, in which case subroutine 600 may obtain an activity indication in block 630 by observing data passed through the proxy.

Similarly, in some embodiments, a user may access an online interactive feature using a special or modified client that enables subroutine 600 to monitor events on the user's computing device. In such embodiments, subroutine 600 may select branch 635. In block 640, subroutine 600 may obtain an activity indication by observing events on the user's computing device. For example, subroutine 600 may be able to observe an activity indication by monitoring mouse click events and/or key press events in a web browser.

In some embodiments, subroutine 600 may not be able to automatically obtain an activity indication, in which case subroutine 600 may select branch 645, request an activity indication from the user, and receive the activity indication in block 650. For example, subroutine 600 may receive from the user a URL or other URI and/or a content object as an activity indication. In some embodiments, a content object may comprise text and/or binary data that is available on- and/or off-line. For example, in one embodiment, subroutine 600 may receive in block 650 an image file depicting the user at a particular location and/or other photographic evidence that the user completed an offline activity. In other embodiments, subroutine 600 may obtain photographic evidence via other methods, such as a feed of images from a webcam, a security camera, or other sources of automatically-generated images.

Branches 615, 625, 635, and 645 are merely non-limiting illustrative examples of methods to obtain activity indications. In other embodiments, subroutine 600 may employ alternate methods of obtaining activity indications. Subroutine 600 returns at block 699.

FIG. 7 is a flow diagram illustrating an activity completion verification subroutine 700 in accordance with one embodiment. In decision block 705, subroutine 700 determines the activity completion criterion (see discussion of block 512 in FIG. 5, above) for the unverified activity indication and selects an appropriate method to verify that the activity indication satisfies the activity completion criterion.

For example, in one embodiment, the activity indication may comprise a content object, such as an HTML page, an XML document, a JSON object, an image, and the like; and the activity completion criterion may call for inspecting the content object. When the unverified activity indication comprises a content object, subroutine 700 may select branch 710 and inspect the contents of the content object in block 715 to determine whether the content object satisfies the activity completion criterion. In various embodiments, inspecting the contents of a content object, as in block 715, may comprise some or all of the following: selecting nodes from an XML document using an XML Path Language (“XPath”) expression; identifying strings within a text document using regular expressions; selecting elements in a HyperText Markup Language (“HTML”) or Extensible Hypertext Markup Language (“XHTML”) document using Cascading Style Sheets (“CSS”) Selectors; extracting information using a client- or server-side script; and the like. In some embodiments, a content object may also comprise an image and inspecting the contents of a content object may comprise parsing the image using recognition technology to identify faces, particular persons, and/or particular places in the image.

In some embodiments, the activity indication may comprise a URI (e.g., a URL), and the activity completion criterion may call for determining the existence or non-existence of a resource located at the URI. In such embodiments, subroutine 700 may select branch 720 and validate the URI in block 725. For example, one exemplary online activity may include “Create a Listmania List” at Amazon.com, operated by Amazon.com, Inc. of Seattle Wash. In one embodiment, when a user indicates that he or she created a Listmania list, subroutine 700 may use the existence of non-existence of the user's “Listmania” page at Amazon.com to verify the activity indication.

In other embodiments, the activity indication may comprise an indication received by activity verification server 200 from a client verification routine (e.g., a desktop software verification client, a browser plug-in, and the like). For example, in some embodiments, a client verification routine may perform all or part of subroutine 700 and communicate an activity completion assertion to activity verification server 200. In such embodiments, activity verification server 200 may perform its own activity completion verification subroutine 700 to, for example, authenticate the client and/or validate the activity completion assertion prior to treating the activity completion assertion as a verified activity completion indication.

Referring again to decision block 705, in still further embodiments, the activity indication may comprise a geolocation-based indication (e.g., latitude and longitude coordinates) or location-based indication (e.g., cellular and/or wi-fi position system indications), and the activity completion criterion may call for determining whether the (geo)location-based indication is sufficiently proximate to a target location. In such embodiments, subroutine 700 may select branch 740 and validate the (geo)location-based indication in block 745. For example, a geolocation-based activity indication may be submitted via the user's Global Positioning System (“GPS”) enabled device (e.g., a standalone GPS unit, a mobile phone, a digital camera, and the like), indicating that the user was physically present at a particular geolocation. In this case, subroutine 700 may determine in block 745 whether the user's indicated location is sufficiently proximate to a target geographical location, landmark, or other location-based identifier. (I.e., in this case, determining whether the submitted geolocation-based activity indication satisfies the activity completion criterion may comprise determining whether the geolocation-based activity indication is in the vicinity of, e.g., the Pacific Science Center in Seattle Wash.)

In other embodiments, a user's location may be inferred without use of GPS via observing nearby signal sources (e.g., cellular towers, wireless hotspots, and the like) that may be correlated to known physical locations. In some embodiments, a location-aware device may automatically scan a list or database of known activities to determine whether the user's current location matches any activities. For example, a location-aware device may know that a user is in proximity to the Space Needle in Seattle, Wash., and the location-aware device may identify and mark as completed a “Visit Space Needle” activity from a list or database of known activities. In such a manner, a user might complete activities of which he or she was unaware, simply by visiting a particular location.

Referring again to decision block 705, in some embodiments, the activity indication may comprise a time-based indication, and the activity completion criterion may call for determining whether the time-based activity indication is within a time-window. In such embodiments, subroutine 700 may select branch 730 and validate the time-based indication in block 735.

In some embodiments, an activity completion criterion may include two or more sub-criteria, and in decision block 750, subroutine 700 determines whether there are additional criteria to evaluate to verify the submitted activity indication. If subroutine 700 determines that the activity completion criterion includes an additional sub-criterion, subroutine 700 loops back from decision block 750 to decision block 705. In this manner, subroutine 700 may evaluate two or more branches of decision block 705 in the course of verifying that an activity indication satisfies a completion criterion. For example, an activity completion criterion may comprise a temporal sub-criterion as well as another criterion. In such case, subroutine may evaluate the temporal sub-criterion on one iteration, and the other criterion on another iteration. (In some embodiments, multiple sub-criteria may also be evaluated in parallel.)

If subroutine 700 determines in block 750 that there are no additional activity completion criteria to evaluate, subroutine returns at block 799. Branches 710, 720, 730, and 740 are merely non-limiting illustrative examples of methods to verify that an activity indication satisfies a completion criterion and/or two or more completion sub-criteria. In other embodiments, subroutine 700 may employ alternate methods of verifying activity indications.

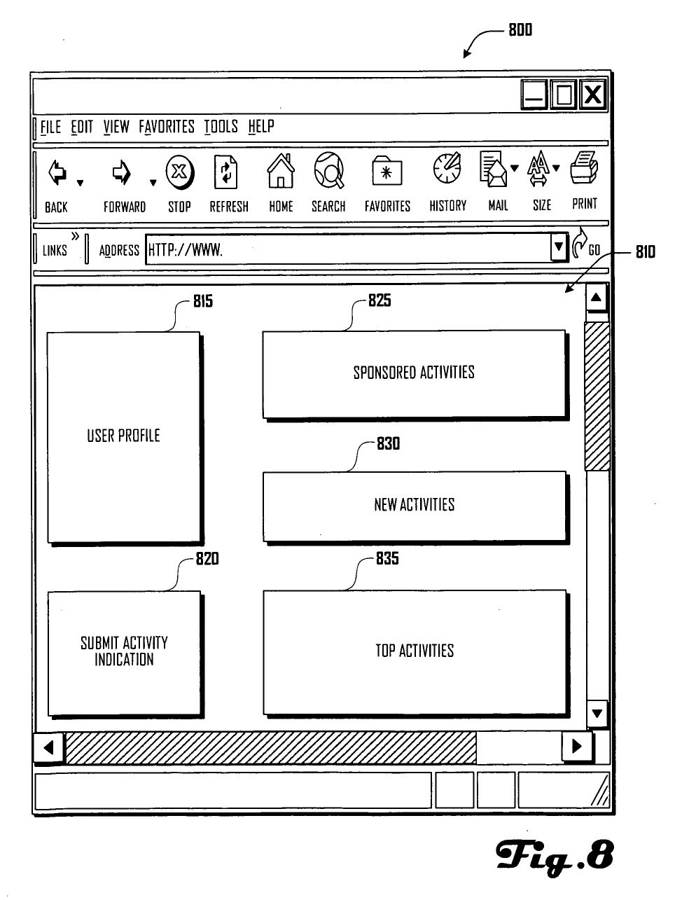

FIG. 8 is an illustration of a online action verification user interface window 800 in accordance with one embodiment. Window 800 includes a content area 810 having several sub-areas. Area 815 may display information related to a user and/or a user's profile. Control area 820 may facilitate a user to request activity verifications, submit activity indications for verification, and the like. Area 825 may display one or more “sponsored” and/or featured activities. In some embodiments, an activity service provider may pay and/or competitively bid for placement in sponsored activities area 825. Area 830 may display recently added activities, and area 835 may display activities that are completed most frequently, rated highly, and the like.

As discussed above, various embodiments of an activity verification online service provider may generate data related to activities that users have verifiably experienced and/or completed. In various embodiments, a “commitment mechanism” may comprise an exemplary application that is enabled and/or facilitated by activity verification online service provider.

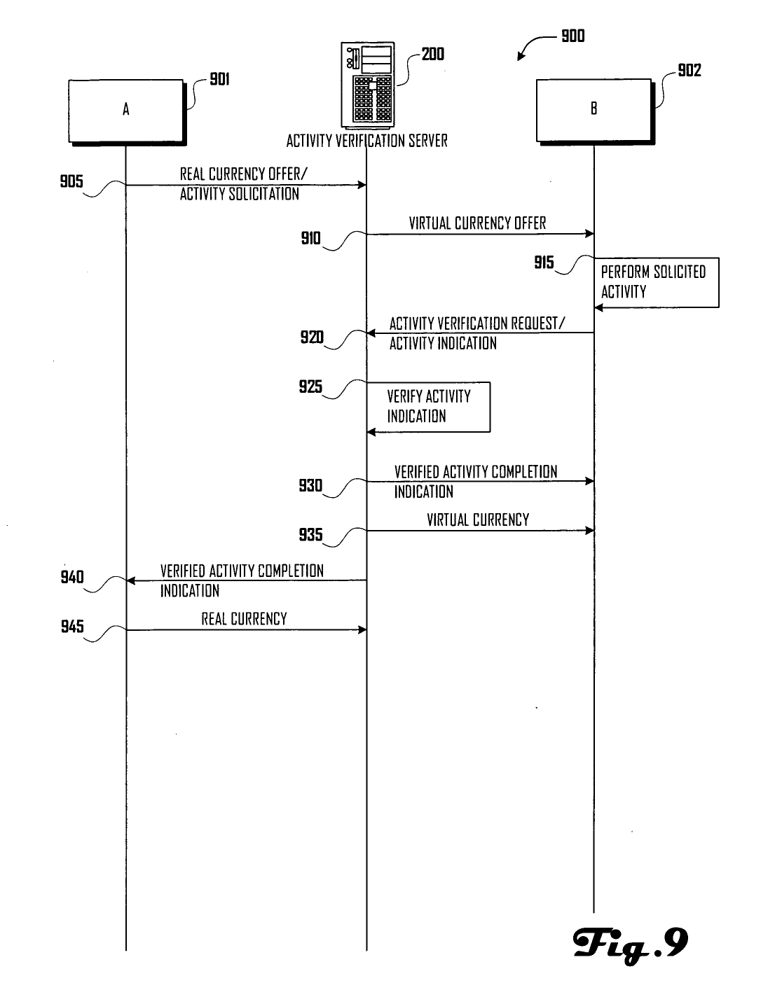

FIGS. 9-11 are data flow diagrams illustrating exemplary elements related to various embodiments of a “commitment mechanism.” In other embodiments, various elements illustrated in FIGS. 9-11 may be combined with one another and/or expanded upon.

In some respects, a commitment mechanism, such as those illustrated in FIGS. 9-11, may be considered to be a generalized form of activity promotion and verification routine 400, as illustrated in FIG. 4 and discussed above. Broadly speaking, as the term is used herein, “commitment mechanism” refers to a system and/or method that facilitates one user (“User A”) to induce another user (“User B”) to verifiably perform an activity (“Activity”), possibly in exchange for a reward, bounty, or other inducement (“Reward”).

An Activity may comprise online and/or offline activities, or any combination thereof. In some embodiments, activity verifications may be performed automatically, as illustrated in FIGS. 5-7 and discussed above. In other embodiments, other verification mechanisms, e.g., peer-judged “cred” mechanisms (see Appendix A, below), may be used. In some embodiments, a combination of verification mechanisms may be employed.

In this context, a Reward may comprise an amount of real currency, an amount of virtual currency, one or more verification credits, and/or other like inducement. In some embodiments, a Reward may also include a promise to perform another verifiable Activity. For example, User A may, as a Reward, offer to verifiably shave his or her head (an activity that may be verified via a peer-judged “cred” mechanism, such as that discussed in Appendix A, below).

Typically in this context, either User A or User B may refer to an individual person, while the other refers to an activity service provider. However, in some embodiments, both of Users A and B may refer to individual persons, or both of Users A and B may refer to activity service providers. In instances where Users A and B are not already in contact with each other, an activity verification online service provider can be the match-maker.

FIG. 9 illustrates one exemplary data flow sequence 900 in accordance with a “sponsorship-type” commitment mechanism. User A 901 offers 905 real currency to activity verification server 200 if activity verification server 200 will induce User B 902 to verifiably complete a solicited Activity. In the commitment mechanism context, “User B” does not necessarily initially refer to any particular user, but rather to some user that is or will become known to activity verification server 200. In some cases, User A may desire that User B meet one or more criteria, such as a demographic criteria, a degree-of-activeness criteria, a ranking criteria, and the like.

To accept the real currency offer, activity verification server 200 induces User B to perform the solicited Activity. Activity verification server 200 offers 910 a virtual currency reward to User B 902. User B performs 915 the solicited activity and submits 920 an activity verification request to activity verification server 200, along with an activity indication. (In other embodiments, activity verification server 200 may obtain activity indication other than from User B. For example, activity verification server 200 may obtain the activity indication as illustrated in FIG. 6, discussed above.) Activity verification server 200 verifies the activity indication and provides 930 a verified activity completion indication to User B 902. (For example, see FIGS. 5-7, discussed above.) Activity verification server 200 also provides 935 the previously-offered virtual currency to User B 902.

Activity verification server 200 provides 940 verified activity completion indication to User A 901, User A 901 provides 945 the offered real currency to activity verification server 200. In some embodiments, User A may provide the real currency to activity verification server 200 prior to User B's completion of the solicited activity. In a sense, activity verification server 200 may hold an offered Reward in “escrow,” pending verified activity completion by User B. Conversely, in some embodiments, an activity verification online service provider may act as a “shaming agent,” publicizing User B's failure to perform an activity that User B indicated was performed and/or promised to perform.

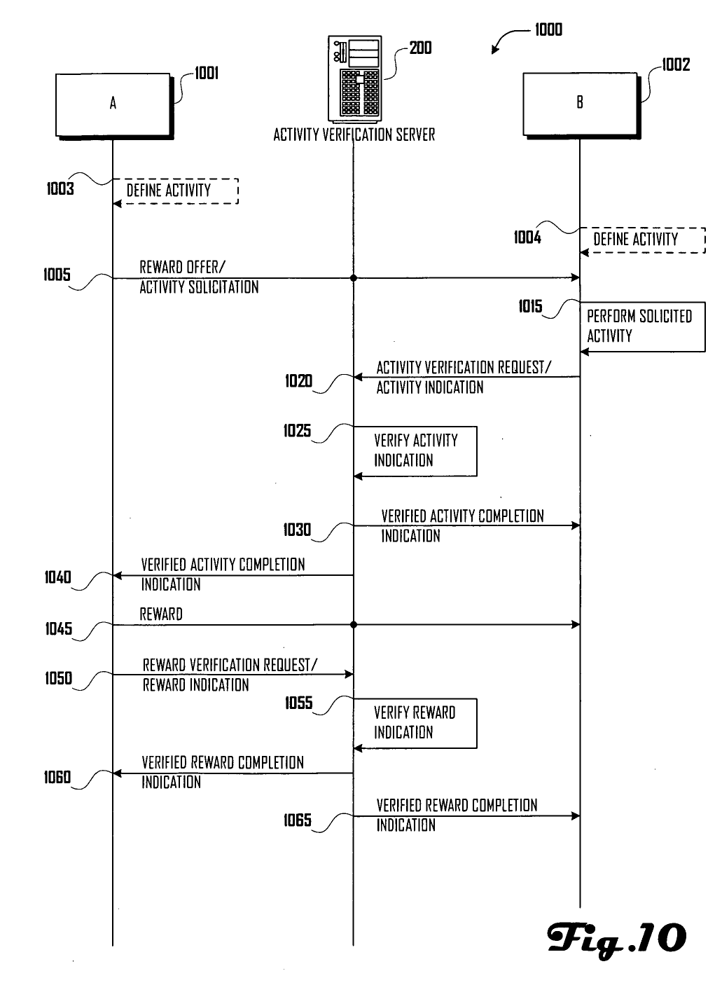

FIG. 10 illustrates an exemplary data flow sequence 1000 in accordance with an alternate commitment mechanism, in which User A solicits an Activity and offers a Reward directly to User B. In some embodiments, one or both of User A 1001 and User B 1002 may define 1003, 1004 the solicited Activity (possibly specifically for this Activity solicitation/Reward offer combination). In other embodiments, the Activity may be pre-defined. In one embodiment, the Activity may comprise two or more sub-activities connected by logical operators such as “AND,” “OR,” “NOT,” “IF/THEN,” and the like.

For example, in one embodiment, an Activity solicitation/Reward offer combination may comprise one or more elements such as the following:
IF User A clears Dungeon A in a Multiplayer Online Game (“MOG”) before User B clears Dungeon A in MOG (as verified by a majority vote of a particular set of MOG players, e.g., members of a particular guild), then User B will give User A 100 virtual MOG currency units (which may be automatically verified by activity verification server 200) or shave his or her head (as automatically verified or verified using a peer-judged “cred” mechanism, see below);
ELSE IF User B clears Dungeon A in MOG before User A clears Dungeon A in MOG (as verified by a majority vote of, e.g., MOG guild members), then User B will give User A 100 virtual MOG currency units (which may be automatically verified by activity verification server 200) or shave his or her head (as automatically verified or verified using a peer-judged “cred” mechanism, see below).

User A 1001 offers 1005 a Reward to User B 1002, if User B 1002 verifiably completes a solicited Activity. In some embodiments, this offer/solicitation may comprise a “Challenge,” as discussed in Appendix A, below. To accept the Reward offer, User B performs 1015 the solicited activity and submits 1020 an activity verification request to activity verification server 200, along with an activity indication. (In other embodiments, activity verification server 200 may obtain activity indication other than from User B. For example, activity verification server 200 may obtain the activity indication as illustrated in FIG. 6, discussed above.) Activity verification server 200 verifies the activity indication and provides 1030 a verified activity completion indication to User B 1002. (For example, see FIGS. 5-7, discussed above.)

Activity verification server 200 provides 1040 verified activity completion indication to User A 1001. In an alternate embodiment, User B 1002 may provide verified activity completion indication to User A 1001, instead of or in addition to its being provided by activity verification server 200.

Having received a verified activity completion indication from activity verification server 200 and/or User B 1002, User A 1001 provides 1045 the offered Reward to User B 1002. In an exemplary embodiment, the Reward may be provided 1045 via activity verification server 200. In alternate embodiments, the Reward may be provided directly from User A 1001 to User B 1002, without activity verification server 200 acting as intermediary.

In some embodiments, as noted above, the Reward may comprise a verifiable activity. For example, as discussed above, User A may have offered to shave his or her head as a Reward. In such embodiments, User A may further submit 1050 a Reward activity indication and verification request to activity verification server 200. If a Reward activity indication is submitted, activity verification server 200 verifies 1055 the Reward activity and provides 1060, 1065 verified reward completion indications to one or both of Users A and B 1001, 1002.

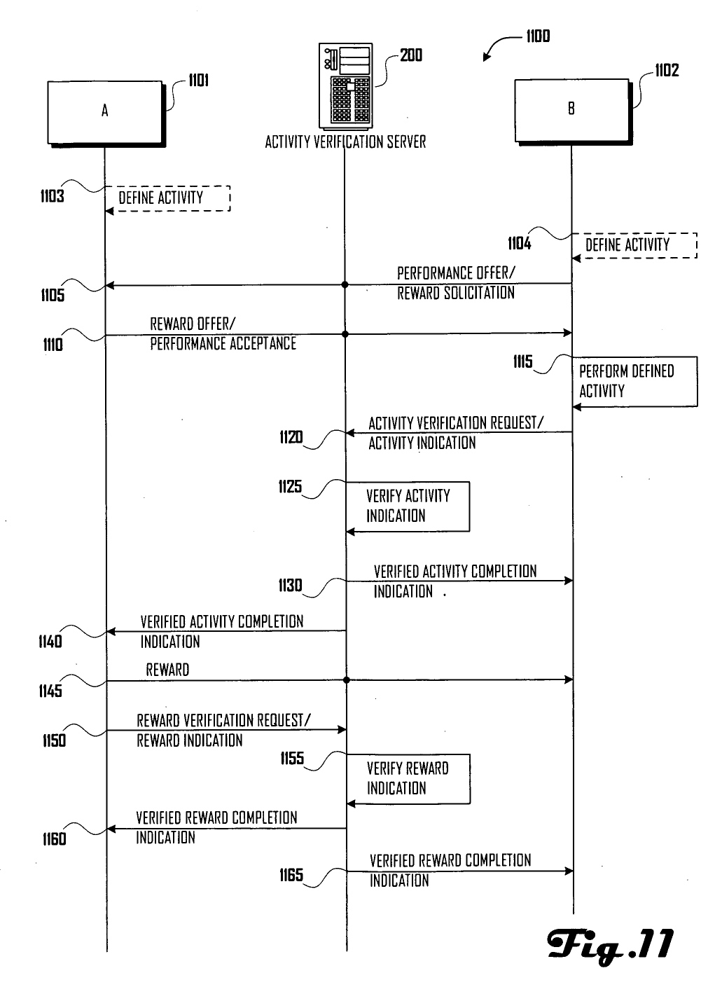

FIG. 11 illustrates one exemplary data flow sequence 1100 in accordance with a “first-mover-type” commitment mechanism. In some embodiments, one or both of User A 1101 and User B 1102 may define 1103, 1104 an Activity. In other embodiments, the Activity may be pre-defined. In one embodiment, the defined Activity may comprise two or more sub-activities connected by logical operators such as “AND,” “OR,” “NOT,” “IF/THEN,” and the like.

User B 1102 signals his/her/its willingness to perform an Activity (regardless of how the Activity was defined), offering 1105 performance of the Activity and soliciting a Reward. User A 1101 accepts 1110 the performance offer and offers a Reward to User B 1102. In some embodiments, activity verification server 200 may intermediate these and similar communications between Users A and B 1101, 1102; in other embodiments, activity verification server 200 may “introduce” and/or “match” Users A and B 1101, 1102, who may thereafter communicate directly with one another.

User B performs 1115 the Activity and submits 1120 an activity verification request to activity verification server 200, along with an activity indication. (In other embodiments, activity verification server 200 may obtain activity indication other than from User B. For example, activity verification server 200 may obtain the activity indication as illustrated in FIG. 6, discussed above.) Activity verification server 200 verifies 1125 the activity indication and provides 1130 a verified activity completion indication to User B 1102. (For example, see FIGS. 5-7, discussed above.)

Activity verification server 200 provides 1140 verified activity completion indication to User A 1101. (In some embodiments, User B 1102 may provide the verified activity completion indication to User A 1101 instead of or in addition to activity verification server's 200 providing the verified activity completion indication.) User A 1101 provides 1145 the offered Reward to User B 1102, possibly using activity verification server 200 as an intermediary.

In some embodiments, as noted above, the Reward may comprise a verifiable activity. For example, as discussed above, User A may have offered to shave his or her head as a Reward. In such embodiments, User A may further submit 1150 a Reward activity indication and verification request to activity verification server 200. If a Reward activity indication is submitted, activity verification server 200 verifies 1155 the Reward activity and provides 1160, 1165 verified reward completion indications to one or both of Users A and B 1101, 1102.

Although specific embodiments have been illustrated and described herein, it will be appreciated by those of ordinary skill in the art that a whole variety of alternate and/or equivalent implementations may be substituted for the specific embodiments shown and described without departing from the scope of the present disclosure. This application is intended to cover any adaptations or variations of the embodiments discussed herein.

Appendix A, which follows, describes additional aspects of various embodiments, including user profiles, a challenge/dare mechanism, a peer-judged verification mechanism (“Cred”), and a payment mechanism.

### APPENDIX A

One or more data elements may emerge when activities list 260 and list of users 265, as illustrated in FIG. 2, are considered in combination. In various embodiments, such emergent data elements may include some or all of the following:
Verification;
Experience points (“XP”);
User profiles;
User comparisons.

Verification

In some embodiments, a user may be able to confirm or verify that another user completed an activity. Verification may add certainty to elements of list of activities 260. For example, in one embodiment, activities may be ranked by completions using only those completions that have been confirmed. Similarly, “expected time” (“XT”), “expected difficulty” (“XD”), and/or “expected value” (“XV”) statistics may be based at least in part on input from users with verified completion indications of the relevant activities, rather than include data from users with merely “claimed” or unverified completion indications.

Experience points (“XP”)

In one embodiment, XP may signify the total “experience” a user has gained both from individual activities and from various sets of the activities they have completed. In one embodiment, XP for a user for an activity may be calculated according to a formula such as the following:

XP=(Completion Difficulty)×(Completion Certainty)

In the above equation, (Completion Certainty) refers to the degree of certainty associated with a particular completion indication. For example, in one embodiment, a user's completion indication for a particular activity may be “verified” or “unverified.”

In various embodiments, (Completion Difficulty) may be measured in any of several ways. In one embodiment, (Completion Difficulty) may be measured on an arbitrary numerical scale according to user reports. In another embodiment, (Completion Difficulty) may be measured by the “expected time” (“XT”) for that activity. In another embodiment, the expected number of completes of a activity could be computed based on how many users viewed a description of the activity and on what the “value” rating of the activity is. In some embodiments, the actual number of verified completion indications may be compared to the expected number of completes, and it may be inferred that activities with fewer than expected completes are probably more difficult than those with more than expected completes.

In one embodiment, XT may influence (Completion Difficulty) as illustrated in the following example:
User A has completed 3 activities with XT of 5 minutes, 10 minutes, and 15 minutes, respectively;
User B confirmed that User A completed the 5 and 10 minute activities, but User A has no confirmation that he or she completed the 15 minute activity;
User A would have 30 “claimed” XP (since all completed activities are automatically claimed even if they are also verified) and 15 “confirmed” XP.

In some embodiments, XP for a user may be summed across some or all the activities he or she has completed, as well as across a sub-set of activities. For example, if a user has completed a) two activities related to baseball for 10XP and 15XP respectively; b) three activities related to soccer for 5XP, 10XP, and 15XP respectively; and c) one activity related to dish-washing for 30XP; that user may have 25XP in baseball, 30XP in soccer, 55XP in sports (assuming that baseball and soccer are sports, but dish-washing is not), and 115XP in total.

User Profiles

In some embodiments, some or all users may have stored profiles, including various types of information, such as:
Unverified activity indications submitted by a user
Verified activity indications submitted by a user
The sum of a user's XP from some or all submitted activity indications.

In various embodiments, the sum of a user's XP sum may be subdivided in several ways, including between those activity indications that are unverified and those that are verified, as well as between activities associated with different tags or other identifiers. In some embodiments, a user may be able to publish his or her profile to other locations, such as blogs, social network profile pages, and e-mail “signatures.”

User Comparisons

In exemplary embodiments, users may be compared in a variety of methods. For example, users may be compared according to the number of activities completed and/or the sum of some descriptor of the activities completed, such as XP, XT, and XD. In various embodiments, activities used for comparison may be limited or filtered in a variety of ways, including only looking at those that are either verified or unverified, and only looking at activities that are tagged in a particular way, e.g., “soccer.”

In various embodiments, the number of users in any particular comparison may be limited. For example, in one embodiment, a comparison might be among only users who are within n degrees of a user in terms of “friendship” or other relatedness vector and/or distance graph. In another embodiment, only users who have completed, e.g., soccer-tagged and/or soccer-related activities may be compared.

In various embodiments, users may be compared according to some or all of a variety of statistical methods. In one embodiment, a user may be compared with a mean. For example, “Bob has completed twice as many activities as the average user.” In another embodiment, a user may be ranked with other users. For example, “Bob ranks in the 95th percentile in number of activities completed.”

These and similar inter-user comparisons may be displayed in a variety of places, including on purpose-designed pages, often referred to as “leader boards,” and/or on user profile pages.

“Challenge Someone” Mechanism.

Users, advertisers, and/or the activity verification online service provider may “challenge someone,” i.e., suggest/demand that one or more people complete an action. In an exemplary embodiment, the basic “flow” of challenges is as follows:
A user issues a challenge
A user commits to, or rejects, the challenge
A user completes, or abandons, the challenge

Any particular instance of “challenge someone”—a “challenge”—may have several variables, including:
Who is challenged
What the person is challenged to do
What the challenger offers in return
The certainty of completion required
Logical operators

Declaration

In one embodiment, the challenger challenges himself, and self-generated challenges may be automatically accepted, thereby “committing” the user to completing the activity. In another embodiment, a challenger may challenge everyone, such that any other person may take up the challenge. In yet another embodiment, a challenger may challenge one or more specific other people. In a final exemplary embodiment, a challenger may challenge all those who have particular characteristics, e.g., everyone who has completed at least two challenges tagged “Gucci,” everyone who is a friend or a friend-of-friend of the challenger, and the like.

In its simplest form, a challenge would contain one activity. However, challenges may also contain multiple activities, e.g., “I challenge you to swim across Lake Union AND climb the Space Needle.”

The activity may already exist in the database of activities, but the challenge activity may also be entered by the challenger as part of the “challenge someone” process. In one embodiment, the challenger may use any action that has some meaning within the context. For example, a user might be able to challenge someone to challenge someone.

In its simplest form, “challenge someone” offers nothing in return. However, in one embodiment, the challenging user may be able to offer something in return to the challenged user. For example, a user may offer to complete another challenge in return, e.g., “If you swim across Lake Union, then I will swim across Lake Union.”

In one embodiment, a challenger may set the level of certainty that he or she would like the challenge results to meet. For example, the challenger may require that the completer's complete be confirmed by one or more of the other parties to the challenge. Alternatively, the challenger may say that the completer's complete need only be claimed.

Conditionals and logical operators may be used to construct challenges. For example, a challenge might be “If you swim across Lake Union or pay me US$100, then I will swim across Lake Union and do a back flip.” Examples of conditionals and logical operators that the System may allow include: If/then; And/or; and the like.

In an exemplary embodiment, when a user challenges him- or her-self, a “declaration” object may be created with an associated declaration state, validation type, and proof state. The initial declaration state may default to “accepted,” i.e., the user has accepted the challenge. (Since the user issued the challenge to him- or her-self, acceptance may be automatic in some embodiments.) At this point, the validation type (e.g., “claimed,” “confirmed,” “proven”) is not determined. The proof also does not exist and does not have a state.

In one embodiment, the user has at least two courses of action open. The user may choose to abandon his challenge, in which case the declaration state changes to “Abandoned.” The user may also choose to claim the challenge has been completed, in which case the declaration state changes to “complete claimed” and the validation type becomes “claimed.” At this point, there is no proof, but the user may choose to submit proof of completion, which in one embodiment, is termed “Proof: Create/Proof queued!” If the user does this, the declaration state changes to “Proof queued,” the validation type becomes “Proven” (e.g., submitting proof to be checked by other users), and the proof state becomes “Proof queued,” e.g., the proof is queued to be checked by other users.

The user may also want to submit proof without having the proof immediately enter the judgment queue. This, in one embodiment, is termed “Proof: Create/Proof held!” If the user does this, the declaration state change to “Proof held,” the validation type becomes, “Proven,” and the proof state becomes “Proof held,” e.g., he has proof, but the proof is withheld from the judgment queue.

The user may also choose to take his or her queued proof and hold it (“Hold judgment”) or to take his or her held proof and queue it (“Request judgment”). The user may further choose to take a queued or held proof and delete it (“Delete proof/Proof: Destroy”). This changes the declaration state to “Proof purged” and returns proof to having no state (since the user destroyed the proof).

From the “Proof purged” state, the user may choose to abandon his challenge (“Abandoned!”), in which case the declaration state becomes “Abandoned.” From the “Proof purged” state, the user may also choose to add new proof. The user may do this so that the proof is immediately in queue to be judged (Proof:Create/Proof queued!) or held back from the queue (Proof:Create/Proof held!).

From the “Proof queued” and “Proof held” states, the user may decide to change his proof. In one embodiment, this involves two steps: “Delete proof,” to remove the old proof, and “Proof:Create,” to add new proof, which may either be queued for judgment (“Proof queued!”) or held back from the judgment queue (“Proof held!”)

From the “Proof queued” state, a judge may approve the proof (“Proof approved! Complete proven!”). (Note that, in this example, only a single human judge, rather than a group of human judges, is used to assess the proof.) The declaration state becomes “Complete proven” and the proof state becomes “Proof OK.” Alternatively, from the “Proof queued” state, a judge may reject the proof (“Proof rejected! Complete rejected!”). The declaration state becomes “Complete rejected” and the proof state becomes “Proof rejected.”

From the “Complete rejected” state, the user may choose to remove the proof. If the user simply removes proof without replacing it (“Remove proof”), the declaration state changes to “Proof purged” and the proof returns to a stateless state (since there is no longer any proof). If the user replaces the proof, two steps may be required, first “Remove proof,” then “Proof: Create,” which is either immediately queued (“Proof queued!”) or held back from the judgment queue (“Proof held!”). Finally, from the “Complete rejected” state, the user may choose to abandon the challenge (“Abandoned!”). The declaration state becomes “Abandoned.”

Dare

When a user uses the “challenge someone” mechanism to challenge another user to do something without offering anything in return, a “Dare” object may be created. The “Dare” object has a state and an associated validation type. In this example, the user issuing the challenge chose the validation type “confirmed.” Under the “confirmed” validation type, the dare is not considered complete unless the issuing user confirms that the challenged player completed the challenge. The initial state of the “dare” object is “issued,” i.e., the challenging user has issued the dare, but the challenged player has yet to react to it.

The challenged player may either reject the dare (“Rejected!”) or accept the dare (“Accepted!”), changing the dare state to “Rejected” or “Accepted,” respectively. Once accepted, the challenged user may either abandon the dare (“Abandoned!”) or request that the challenging user confirm that the challenged user completed the challenge (“Confirmation requested!”), changing the dare state to “Abandoned” or “Confirmation requested,” respectively.

After the challenged user requests confirmation of his completion of the challenge, the challenging user may either reject the request (“Complete rejected!”) or confirm that the challenged user completed the challenge (“Complete confirmed!”), changing the dare state to “Complete rejected” or “Complete confirmed,” respectively. If the challenging user rejected his request for confirmation, the challenged user may either abandon the dare (“Abandoned!”) or once again request confirmation (“Confirmation requested!”), changing the dare state to “Abandoned” or “Confirmation requested,” respectively.

Deal

When a user uses the “challenge someone” mechanism to challenge another user to do something and offers something in return, a “Deal” object may be created. The “Deal” object may have two associated “DealDares”—the activities each user must complete. The deal may take the form, “If User A does Activity A, User B does Activity B.” “User A does Activity A” is “DealDare A,” and “User B does Activity B” is “DealDare B.” Both deal dares also have an associated validation type. In this example, both deal dares have the validation type “Claimed.”

When the challenging user (“User B”) uses the “challenge mechanism” to create the deal, a deal object with two deal dares may be created. The state of DealDare A is “Issued”—e.g., User B has issued that DealDare to User A-and the state of DealDare B is “Accept pending,” e.g., User B will automatically accept it as soon as User A completes his side of the deal.

User A can either reject the challenge (“Rejected!”) or accept the challenge (“Accepted!”). Rejecting the challenge causes the state of DealDare A to become “Rejected” and the state of DealDare B to become “Abandoned.” Accepting the challenge causes the state of DealDare A to become “Accepted” and doesn't change the state of DealDare B.

Once User A has accepted the deal, User A may either request to abandon the deal (“A:Abandon_requested”) or claim he completed his side of the deal (A:Complete_claimed!). If User A requests to abandon the deal, the state of DealDare A changed to “Abandon requested.” If User A claims he completed his side of the deal, then User B automatically accepts his side of the deal (B:Accepted!). DealDare A's state becomes “Complete claimed” and DealDare B's state becomes “Accepted.”

If DealDare A's state is “Abandon requested,” User B may either approve the request (“A:Abandon_approved!”) or deny the request (“A:Abandon_denied!”). If User B approves the request, DealDare A changes state to “Abandon approved,” and DealDare B is automatically abandoned (“B:Abandoned!”), causing DealDare B to change state to “Abandoned.” If User B denies the request (“A:Abandon_denied!”), DealDare A changes state to “Abandon denied,” leaving DealDare B unchanged.

The actions available to User A if DealDare A's state is “Abandon denied” are the same actions available to User A if DealDare A's state is “Accepted,” with the same consequences. If DealDare A's state is “Complete claimed” and DealDare B's state is “Accepted,” User B can either request to abandon the deal (“B:Abandon_requested!”) or claim to have completed his part of the deal (“B:Complete_claimed!”). If User B claims to have completed his part of the deal (“B:Complete_claimed!”), DealDare B's state changes to “Complete claimed” and both sides of the deal are complete. If User B requests to abandon the deal (“B:Abandon_requested!”), the deal enters the equivalent of the loop it entered when User A requested to abandon the deal (“A:Abandon_requested!”).

Once users commit to completing activities, statistics may be collected to track how users behave following their committing to challenges. This post-commitment information may be presented in a variety of ways. In one embodiment, users may be rated according to the commitments a user made compared to how many of those he or she followed-through on, i.e., completed the committed-to activity. For example, if a user committed to do five activities and has so far completed three, that user may have a follow-through rating of 3/5 or 60%. In another embodiment, a user may be rated according to the length of time from when he or she commits to do an activity compared to the time the user completes that activity. For example, if a user completed three activities in 5, 10, and 15 days after committing to them, that user may have an average follow-through time of 10 days. Follow through statistics may also be divided between “claimed” and “confirmed” completions.

The “challenge someone” mechanism may also be used to introduce variations in previously-mentioned elements. For example, the number of times activities have been the subject of challenges may be tracked. For another example, a user's profile may display data about his or her use of the “challenge someone” mechanism, such as how many times the user issued challenges, completed challenges, or got people to complete challenges. This data could be used as the basis of a “Persuader” score. For example, users may be compared based on each user's use of the “challenge someone” mechanism to form “Persuader” rankings.

CREDIBILITY ASSESSMENT MECHANISM (“Cred mechanism”)

In an exemplary embodiment, the Cred mechanism takes one or more inputs, including some form of proof provided by the completer of the activity, and gives as output an assessment of the credibility of that completion. The mechanism may take two general forms: one where the credibility of the completion is assessed by the users, and another, as discussed in the body of this disclosure, where the credibility of the completion is assessed automatically.

In the first (user-assessed) form, the proof that the completer submitted is reviewed by a one or more other users, who act as judges. In an exemplary embodiment, each judge may view the proof, a description of the activity that the completer claims to have accomplished, and some form of identification that will tie the user to the proof. The proof can be any kind of information, such as an image file, a video, or a declaration by a witness. The form of identification can be anything that the user believes would suit the purpose. For example, if the proof is a photo or video, the identification might be a photograph of the completer's face. If the proof is a screen shot of a Web site, the identification might be the user ID of the completer. Each judge indicates whether he or she believes the proof is sufficient or insufficient to prove that the completer completed the activity in question. In an alternate embodiment, each judge may give a “degree of sufficiency” rating.

The user database may be used to limit the judges that can judge a particular completion. For example, in one embodiment, judges who are “friends” of a particular user may be prevented from judging the friend's completes. In a similar embodiment, a user may be disqualified from judging his own completions. In another embodiment, judges may be required to have completed an activity with a certain aspect before they are qualified to judge completions including activities with the same aspect. For example, judges may be required to have completed activities tagged “soccer” to be qualified to judge completions of activities tagged “soccer.”

In the second (automatic assessment) form, the proof that the completer submitted is reviewed automatically, without human input. Typically, an assessment routine operated by a activity verification online service provider reads the proof, which could be any computer-readable information. The assessment routine looks for information in the proof that shows that the completer completed the action. The assessment routine may also look for something that identifies the completer within the proof. Alternatively, the assessment routine may get the proof in a situation that leads it to believe that the completer completed the proof. The specific mechanism that allows the assessment routine to verify whether a user completed a particular activity may be created by someone affiliated with the activity verification online service provider or, potentially, any user of the System.

In some embodiments, the user-judged form of the Cred mechanism may be used to test the reliability of the second, automatically-judged form of the Cred mechanism. For example, a particular completion may first be automatically assessed. The same information (e.g., user identifier, activity identifier, proof that user completed activity) may then be presented to users acting as judges. In one embodiment, the more user-judges that agree with the automatic assessment, the greater the likelihood that the assessment routine is judging accurately, and vice-versa.

The results of the Cred mechanism may be compiled into a “Cred” score for a completion. In a user-judged embodiment, the judge's votes may be statistically summarized. For example, the Cred score could be calculated in the following manner:
Assuming the votes of judges follow a Student't T-distribution.
Calculating the 95% confidence interval of the mean.
Using the lower end of the 95% confidence interval.

Many other approaches could be used for expressing Cred, such as using the mean or a different confidence interval. The Cred score may also be presented as a fraction, e.g., “⅘ judges say this proof is sufficient.”

Similarly, a variety of methods may be used to create a Cred score for automatically-judged completions. In one embodiment, completions that passed automatic judgments are assigned a Cred score of 100%. In an alternative embodiment, Cred scores may be assigned based on the assessment routine's past degree of agreement with user judges.

In some embodiments, users acting as judges are assessed to ensure they are making meaningful, rather than thoughtless or arbitrary, judgments. User judges may be assessed in some or all of the following manners:
Ranking judges on how well their vote (e.g., “Evidence is sufficient”/“Evidence is insufficient”) predicts the vote of judges who look at the same user/activity/proof combination in the future. Judges whose votes are better predictors may be given higher “judgment scores” and/or ranked higher as judges.
Asking users to match combinations of users, activities, and proof, some of which are the combinations submitted by users and some of which are different. The credibility of the completion is based on how much more likely the user-submitted combination is to be scored as “Sufficient” than a different combination.

In one embodiment, the Cred mechanism may be combined with activity verification online service provider's database of challenges and users, either in a single set or separately with multiple independent databases of challenges and/ or users. In another embodiment, the Cred mechanism may be available for use without being combined with any other mechanisms. In yet another embodiment, the Cred mechanism may be integrated with systems owned or operated by a third party. In that embodiment, the Cred mechanism itself may be run by the third party.

The Cred mechanism may also be used to introduce variations in various aspects discussed herein. In one embodiment, the Cred mechanism may be used in accordance with user-designed activities in the database of activities. Before a user-designed activity is made available to other users, it may be required to be completed by a sub-set of users (such as the designer) and that the completion achieve a certain level of Cred.

The Cred mechanism may also be used in accordance with the activity completion counts. For example, rather than, or in addition to, counting how many people completed an activity in a “claimed” or “confirmed” manner, the number of people may be counted who have completed an activity in a manner shown to be credible by the Cred mechanism. There are several possible variants on this method, for example only counting completions with more than a certain Cred score or adding together Cred scores to count “virtual” completions, e.g., two completions with Cred scores of 50% each would count as one completion.

Another use of the Cred mechanism may be in the calculation of activity duration, difficulty, value, and other aspects. When presenting these ratings, each user's input may be weighted by the Cred of their completion, rather than simply using an arithmetic mean. Consequently, ratings by users who have not credibly completed an activity may be given little or no weight, and those who have credibly completed an activity may be given high weight. For example, the Cred mechanism may be used to calculate an activity duration as follows:
If 3 people completed an activity
They claimed to have completed the activity in 3, 6, and 9 minutes.
The credibility of their completions, in the same order as their ratings, were 20%, 60%, and 70%. (Mean credibility: 50%)
Then the “expected time to complete activity” would be 3*(20%/50%)+6*(60%/50%)+9*(70%/50%)=(1.2+7.2+12.6)/3=7

In another embodiment, the Cred mechanism may be used in the calculation of XP. Previously, we noted that XP is calculated using the formula:

(Completion Difficulty)×(Completion Certainty)=(XP)

The Cred score may be used in accordance with the “Completion Certainty.” For example, if the XT for a activity is 10 minutes, and a user's completion of that activity has a Cred of 50%, then the user may receive 5XP for that activity.

The XP/ Cred score combination may also be applied to user comparisons and profiles. For example, if three users have completed soccer-related activities, and the total of their soccer XP is 15XP, 30XP, and 45XP, respectively, the third (with 45XP in soccer) could be assessed as the #1 soccer-activity-completer, the second (with 30XP) as the #2 soccer-activity-completer, and so on.

Data about a user's participation in the Cred mechanism may also be used for the user's profile and for user comparisons. For example, users may be compared according to the number of completions they have judged.

The Cred mechanism may also be used to create an additional variant on the “required certainty” aspect of the “challenge someone” mechanism. Challengers may be allowed to use the Cred mechanism to require completers to meet a certain result, such as ⅘ judges judge the proof to be sufficient or the completion achieves a Cred score of 80%. The Cred mechanism may also be combined with the “required certainty” and “logical operator” aspects of the “challenge someone” mechanism to require certainties that combine Cred with claim and or confirm, e.g., “If you eat 20 Top Pot donuts in under a minute, and I confirm it or the completion gets a Cred score of above 80%, then I will eat 20 Top Pot donuts.” Moreover, “follow-through” statistics may be divided between completions that are claimed, confirmed, and have some level of Cred.

Payment Mechanism.

In alternate embodiments, variants in a payment mechanism may include:
The unit of value used in the payment
The parties involved in the payment
What the payer gets in return for their payment
The conditions for the payment

The unit of value used in the payment: In one embodiment, the payments in the payment mechanism would be made using a virtual currency bought using real currency, such as US Dollars. Other embodiments may use other payment units, or mixtures of payment units, such as real currency, airline miles, lottery participation rights, beads, and the like.

The parties involved in the payment: Payments may be from user to users, from the activity verification online service provider to users, or from users to the activity verification online service provider. In addition, it is possible that non-users are parties to payments.

Payers may make payments for a variety of purposes. One purpose may be to receive judgment on a completed activity. For example, a user may have completed an activity and want to submit proof and receive Cred. In this situation, if the user cannot or does not want to use an automatic judgment, the user requires other users to act as judges. The user may choose to use the payment mechanism to offer a reward to other users who judge his or her completion.

In an alternate embodiment, the activity verification online service provider may provide human judges, in which case the user may be paying the activity verification online service provider. In another embodiment, automatic judging may be available for the activity the user completed, and the user may want to use automatic judging. In that case, the user may pay the activity verification online service provider for the automatic judging service. Alternatively, the automatic judging may be provided by another user, in which case the user may be paying the user who provided the automatic judge. In another variant, the activity verification online service provider may pay human judges to judge a particular completion to find out if the human judges will reach the same conclusion as an automatic judge.

A related purpose may be to try to receive the judgment sooner. The activity verification online service provider may control the order in which proofs of completion are presented to judges for judgment. A user may find it valuable to have their proof of completion presented early in that order. The completer may be able to pay the activity verification online service provider to have his proof presented early in the order. In a variant on this, a user who is not the completer may make the payment in lieu of the completer.

Another purpose may be to persuade one or more users to complete one or more activities. Using the “challenge someone” mechanism, a user or the activity verification online service provider could challenge one or more other users to complete an activity (which may or may not be in the database of activities) and offer a payment in return.

A related purpose may be to try to get more users to notice the activity that the user wants one or more other users to complete. The activity verification online service provider may control the order in which activities are presented to users. A user may find it valuable to have the activity he would like others to complete presented early in that order. The user may be able to pay the activity verification online service provider to have his activity presented early in the order.

In a related purpose, the activity verification online service provider may pay users to use the “challenge someone” mechanism to persuade other users to complete activities that users have asked the activity verification online service provider to present to users.

Another purpose may be to convince users to help build the content for the activity verification online service provider. For example, the activity verification online service provider or other users may pay users to design activities, building the database of activities, or recruit new users, building the database of users. The activity verification online service provider or other users may also pay users to flag inappropriate activities, to tag activities, enter the amount of time required to complete an activity, rate the difficulty or value of completing an activity, or otherwise enrich the information available about activities.

Data about a user's use of the payment mechanism may be tracked in the user's profile and may also be used for user comparisons. For example, users may be ranked according to how much of the payment unit they have paid out (e.g., a “Burner” or “Spender” ranking). In other examples, users may be ranked according to how much of the payment unit a user has been paid (“Earner”) or the combination of the two (“Earn & burner”).

Payments may also be included as objects in the “challenge someone” mechanism, e.g., “I challenge you to pay me 50 payment units,” “I will pay you 100 payment units if you eat chicken noodle soup on top of the Space Needle.”

A activity verification online service provider and users may be able to specify various conditions for payments. For example, a user bidding to have an activity placed early in the order of activities that are presented to users may pay if another user sees the activity, somehow interacts with the activity, or completes the activity. The “complete” may further have “certainty” requirements, such as claimed, confirmed, or a particular Cred score. In another example, if the activity verification online service provider is paying users who design activities, the activity verification online service provider may only pay if the design is both new and if other users complete the designed activity with a particular degree of certainty.

The payment mechanism may also be used to introduce variations in previously-mentioned aspects. For example, the payment mechanism may be used to ensure that human judges are making efforts to judge completions correctly. In one embodiment, an opinion market about the credibility of a certain completion may be created. In another embodiment, judges may be paid if their judgment of a particular completion is the same as another judge's previous judgment of the same completion, and judges may be monetarily penalized if their judgment is different from the previous judge's judgment.

We claim:

1. A computer-implemented method for verifying online activity completion indications, the method comprising:
obtaining, by a first computing device associated with a first online service provider, a first unverified activity indication associated with i) a first online user identifier and ii) a first interactive online feature provided via a second computing device operated by a second online service provider;
verifying, by said first computing device, that said first unverified activity indication satisfies an activity completion criterion associated with said first interactive online feature; and
providing, by said first computing device, a first verified activity completion indication associated with said first interactive online feature and said first online user identifier.

2. The method of claim 1, wherein obtaining said first unverified activity indication comprises retrieving said first unverified activity indication from a resource identifier inferred in accordance with said first online user identifier.

3. The method of claim 1, wherein obtaining said first unverified activity indication comprises receiving said first unverified activity indication from a user associated with said first online user identifier.

4. The method of claim 1, wherein obtaining said first unverified activity indication comprises automatically monitoring events occurring on a user computing device associated with said first online user identifier.

5. The method of claim 1, wherein obtaining said first unverified activity indication comprises monitoring data communications between said second computing device and a user computing device associated with said first online user identifier.

6. The method of claim 1, wherein verifying that said first unverified activity indication satisfies an activity completion criterion comprises inspecting at least one of i) a content object associated with said unverified activity indication, ii) a uniform resource identifier associated with said unverified activity indication, and iii) a temporal identifier associated with said unverified activity indication.

7. The method of claim 1, further comprising
obtaining a verification credit associated with said first online user identifier; and
checking a verification credit balance associated with said first online user identifier before verifying that said first unverified activity indication satisfies an activity completion criterion.

8. The method of claim 7, wherein obtaining a verification credit associated with said first online user identifier comprises obtaining a payment from a user associated with said first online user identifier.

9. The method of claim 7, further comprising debiting said verification token balance associated with said first online user identifier.

10. The method of claim 1, further comprising providing a bounty associated with said first verified activity completion indication to a user associated with said first online user identifier.

11. The method of claim 10, wherein said bounty is sponsored by said second online service provider.

12. The method of claim 10, wherein said bounty comprises at least one of a virtual currency award and a verification token that can be redeemed via said first computing device for subsequent activity indication verifications.

13. The method of claim 1, further comprising providing a notification of said first verified activity completion indication to said second online service provider.

14. The method of claim 1, further comprising selecting a distinguished interactive online feature for promotion in accordance with competitive bids from a plurality of online service providers.

15. The method of claim 1, further comprising correlating at least one of said first verified activity completion indication and said first online user identifier with an event that generates revenue for said second online service provider.

16. The method of claim 15, further comprising obtaining, by first online service provider, an affiliate payment from said second online service provider.

17. The method of claim 1, further comprising obtaining compensation from said online service provider for providing said first verified activity completion indication.

18. The method of claim 1, further comprising recommending, in accordance with said first interactive online feature, a second interactive online feature to a user associated with said first online user identifier.

19. The method of claim 1, further comprising:
identifying a plurality of second online user identifiers with associated completion indications similar to said first verified activity completion indication; and
indicating said identified second plurality of online user identifiers to a user associated with said first online user identifier.

20. The method of claim 1, further comprising ranking said first online user identifier and a plurality of other online user identifiers in accordance with said first verified activity completion indication and a plurality of other verified activity completion indications variously associated with at least one of said first online user identifier and said plurality of other online user identifiers.

21. The method of claim 1, further comprising:
obtaining, by said first computing device, a second unverified activity indication associated with a second online user identifier and a second interactive online feature provided via a third computing device operated by a third online service provider; and
verifying, by the first computing device, that said second unverified activity indication evidences an activity completion associated with said second interactive online feature and said second online user identifier; and
providing, by said first computing device, a second verified activity completion indication associated with said second interactive online feature and said second online user identifier.

22. A computer-readable storage medium containing instructions that, when executed by a processor, perform a method for verifying online activity completion indications, the method comprising:
obtaining, by a first computing device operated by a first online service provider, a first unverified activity indication associated with i) a first online user identifier and ii) a first interactive online feature provided via a second computing device operated by a second online service provider;
verifying, by said first computing device, that said first unverified activity indication satisfies an activity completion criterion associated with said first interactive online feature and said first online user identifier; and
providing, by said first computing device, a first verified activity completion indication associated with said first interactive online feature and said first online user identifier.

23. A computing device including a processor and a memory, the memory containing instructions that, when executed by the processor, perform a method for verifying online activity completion indications, the method comprising:
obtaining, by a first computing device operated by a first online service provider, a first unverified activity indication associated with i) a first online user identifier and ii) a first interactive online feature provided via a second computing device operated by a second online service provider;
verifying, by said first computing device, that said first unverified activity indication satisfies an activity completion criterion associated with said first interactive online feature and said first online user identifier; and
providing, by said first computing device, a first verified activity completion indication associated with said first interactive online feature and said first online user identifier.
